(19) United States
(12) Patent Application Publication
(10) Pub. No.: US 2012/0047655 A1
(43) Pub. Date: Mar. 1, 2012

(54) INCLINE BASED BED HEIGHT

(76) Inventor: Christopher R. O'Keefe, Batesville, IN (US)

(21) Appl. No.: 12/868,781

(22) Filed: Aug. 26, 2010

(51) Int. Cl. A61G 7/015; A61G 7/018; A61G 7/012

(52) U.S. Cl. 5/610; 5/611

(57) ABSTRACT

A hospital bed has a base, an upper frame above the base, and a lift system to raise and lower the upper frame relative to the base between a low position and a high position. The bed also has control circuitry coupled to the lift system to command operation of the lift system. The control circuitry further includes an angle sensor to provide a signal indicative of an angle at which at least one of the base and the upper frame are tilted away from a substantially horizontal orientation. The control circuitry has an indicator that is activated to indicate to a caregiver that the lift system should be operated to move the upper frame to the low position when the angle sensor indicates that the angle is greater than a threshold amount.

### BACKGROUND

The present disclosure relates to patient support apparatuses such as hospital beds, and particularly to hospital beds having lift systems to raise and lower an upper frame relative to a base. More particularly, the present disclosure relates to hospital beds having electrical circuitry for monitoring conditions of a bed and providing alerts to caregivers.

Patient support apparatuses, such as hospital beds and stretchers, that are used to transport patients from one location in a healthcare facility to another are well known. Many such patient support apparatuses have motorized lift systems to raise and lower upper frames of the beds relative to bases of the beds. As patient support apparatuses are transported throughout a healthcare facility, various ramps and inclines may be encountered. These ramps and inclines present a potential tipping hazard. The tipping hazard is increased if the upper frame of a bed or stretcher is in a raised position and is even further exacerbated if the upper frame is carrying additional medical equipment such as IV pumps attached to IV poles, for example.

### SUMMARY

The present invention comprises one or more of the features recited in the appended claims and/or the following features which, alone or in any combination, may comprise patentable subject matter:

A patient support apparatus may include a base, an upper frame above the base, and a lift system to raise and lower the upper frame relative to the base between a low position and a high position. The patient support apparatus may further include control circuitry coupled to the lift system. The control circuitry may be operable to command operation of the lift system. The control circuitry may have an angle sensor that may provide a signal indicative of an angle at which at least one of the base and the upper frame may be tilted away from a substantially horizontal orientation. The control circuitry may include an indicator that may be activated to indicate to a caregiver that the lift system should be operated to move the upper frame to the low position when the angle sensor indicates that the angle is greater than a threshold amount.

The indicator may include, for example, an audible indicator such as a speaker, buzzer, beeper, or horn. Alternatively or additionally, the audible indicator may include a prerecorded voice message. The indicator may include a visual indicator in lieu of or in addition to the audible indicator. The visual indicator may include a light, a light emitting diode (LED), or graphics on a graphical display screen. The graphics may include a textual message and/or an icon. The visual indicator may flash. Regardless of the type of indicator used, the general idea is to notify a caregiver that the upper frame of the patient support apparatus should be lowered so as to minimize or lessen the chance that the patient support apparatus will tip.

In some embodiments, the angle sensor may be mounted to the upper frame and in other embodiments, the angle sensor may be mounted to the base. The upper frame or base may be elongated such that the patient support apparatus has a longitudinal direction and a lateral direction. The angle sensor may sense tilting in the lateral direction and/or the longitudinal direction. Thus, the angle sensor may be, for example, a single axis or 2-axis accelerometer. The control circuitry may further comprise at least one lift system sensor to sense a position of the lift system. Thus, in connection with those embodiments in which the angle sensor is mounted to the upper frame, any tilting of the upper frame by the lift system, rather than due to a floor incline, is compensated for by the control circuitry in determining whether the threshold amount of angle is exceeded. The lift system may have first and second actuators and the at least one lift system sensor may include a first potentiometer coupled to the first actuator and a second potentiometer coupled to the second actuator.

In some embodiments, the base may include a base frame and casters coupled to the base frame. It is contemplated by this disclosure that a mattress support deck may be coupled to the upper frame. In some embodiments, the mattress support deck may be movable between a horizontal position to support a patient in a lying position and a chair egress position to support the patient in a sitting position. The control circuitry may have a scale system operable to sense an amount of weight carried by the upper frame. The threshold amount of the angle may be adjusted based on the amount of weight sensed by the scale system.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a hospital bed showing a bed frame having a patient support deck supporting a mattress in a horizontal position;

FIG. 2 is a perspective view of the hospital bed of FIG. 1 showing the patient support deck of the bed frame moved to a chair egress position;

FIG. 3 is a block diagram showing an angle sensor (in solid) coupled to an upper frame, or alternatively the angle sensor (in phantom) coupled to a base, and communicatively coupled to control circuitry of the bed, the control circuitry being communicatively coupled to an audible/visual indicator and to motors and sensors of a lift system of the bed;

FIG. 4 is a diagrammatic view showing the bed tilted in a longitudinal direction by an angle α; and

FIG. 5 is a diagrammatic view showing the bed tilted in a lateral direction by an angle β.

### DETAILED DESCRIPTION

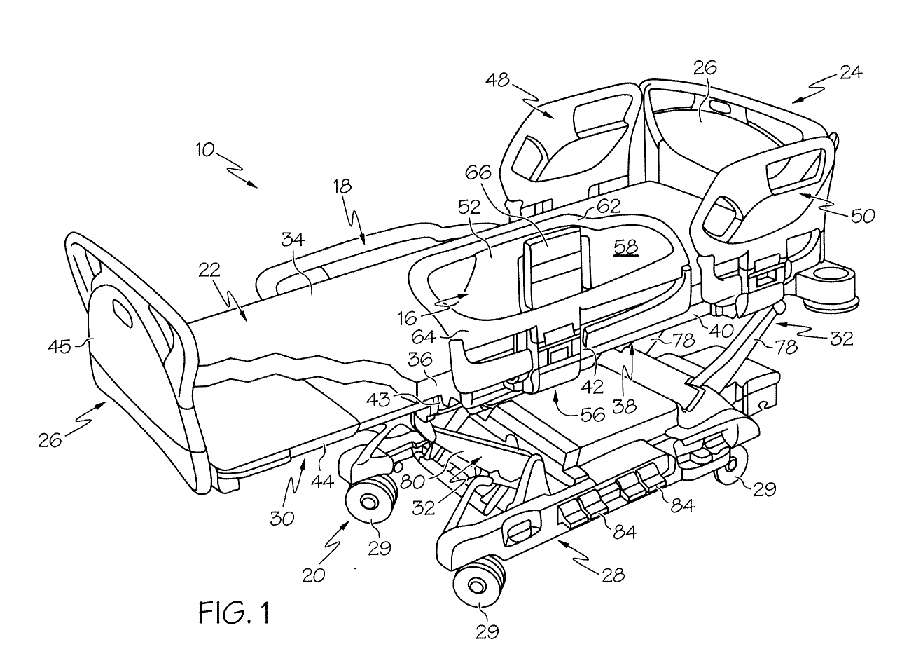

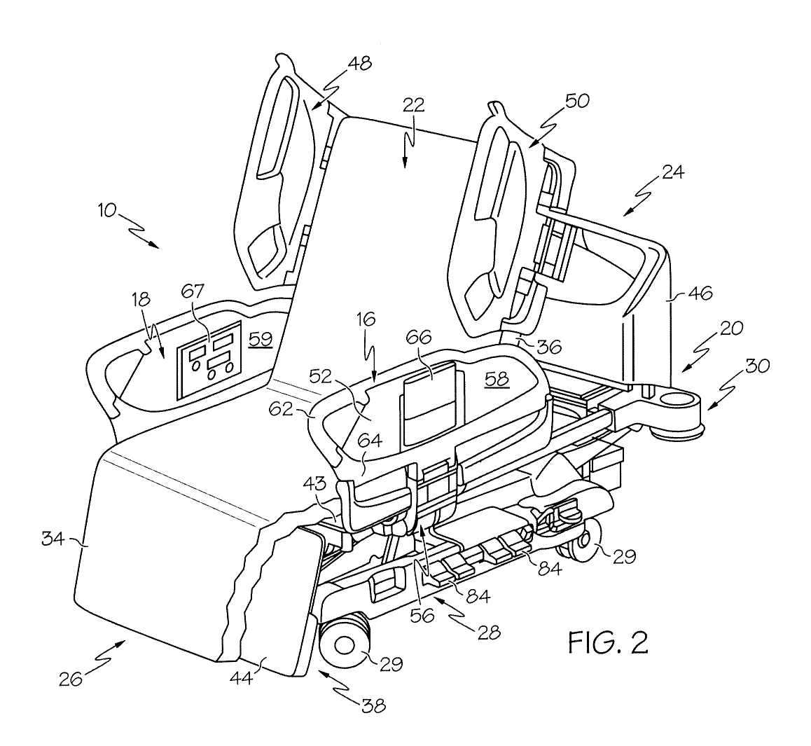

According to this disclosure, a patient support apparatus, such as an illustrative hospital bed 10, is configured to alert a caregiver to lower an upper frame 30 of the bed 10 to a low position if bed 10 is tilted beyond a threshold angle. Illustrative bed 10 is a so-called chair bed that is movable between a bed position as shown in FIG. 1 and a chair egress position as shown in FIG. 2. However the teachings of this disclosure are applicable to all types of hospital beds, including those that are incapable of achieving a chair egress position. Some hospital beds are only able to move into a chair-like position, sometimes referred to by those in the art as a “cardiac chair position,” and this disclosure is equally applicable to those types of beds. Furthermore, the teachings of this disclosure are applicable to other types of patient support apparatuses such as stretchers, motorized chairs, operating room (OR) tables, specialty surgical tables such as orthopedic surgery tables, examination tables, and the like.

Referring now to FIGS. 1 and 2, hospital bed 10 provides support to a patient (not shown) lying in a horizontal position when bed 10 is in the bed position. In the chair egress position, hospital bed 10 supports the patient in a sitting position such that the patient sits on bed 10 with the patient's feet positioned on an underlying floor. Thus, the chair egress position is often used by patients and caregivers to help patients egress or exit the hospital bed 10. Hospital bed 10 includes a frame 20 that supports a mattress 22 as shown in FIGS. 1 and 2. Bed 10 has a head end 24 and a foot end 26.

Frame 20 includes a base 28 and an upper frame 30 coupled to the base 28 by a lift system 32. Lift system 32 is operable to raise, lower, and tilt upper frame 30 relative to base 28. Hospital bed 10 further includes a footboard 45 at the foot end 26 and a headboard 46 at the head end 24. Footboard 45 is removed prior to bed 10 being moved into the chair egress position as shown in FIG. 2. Illustrative bed 10 includes a pair of push handles 47 coupled to upper frame 30 at the head end 24 of bed 10. Handles 47 are grasped by a caregiver while maneuvering bed 10 along a floor 200 of a healthcare facility. Base 28 includes wheels or casters 29 that roll along floor 200 as bed 10 is moved from one location to another.

Illustrative hospital bed 10 has four siderail assemblies coupled to upper frame 30: a patient-right head siderail assembly 48, a patient-right foot siderail assembly 18, a patient-left head siderail assembly 50, and a patient-left foot siderail assembly 16. Each of the siderail assemblies 16, 18, 48, and 50 is movable between a raised position, as the left foot siderail assembly 16 is shown in FIG. 1, and a lowered position, as the right foot siderail assembly 18 is shown in FIG. 1. Siderail assemblies 16, 18, 48, 50 are sometimes referred to herein as siderails 16, 18, 48, 50.

The left foot siderail assembly 16 is similar to the right foot siderail assembly 18, and thus, the following discussion of the left foot siderail assembly 16 is equally applicable to the right foot siderail assembly 18. The left foot siderail 16 includes a barrier panel 52 and a linkage 56. Linkage 56 is coupled to the upper frame 30 and is configured to guide barrier panel 52 during movement of the foot siderail 16 between the raised and lowered positions. Barrier panel 52 is maintained by the linkage 56 in a substantially vertical orientation during movement of siderail 16 between the raised and lowered positions. The barrier panel 52 includes an outward side 58, an oppositely facing inward side 59, a top portion 62, and a bottom portion 64. A user interface 66 is coupled to the outward side 58 of barrier panel 52 for use by a caregiver (not shown). The inward side 59 faces opposite the outward side 58. As shown in FIG. 2, another user interface 67 is coupled to the inward side 59 for use by the patient 11.

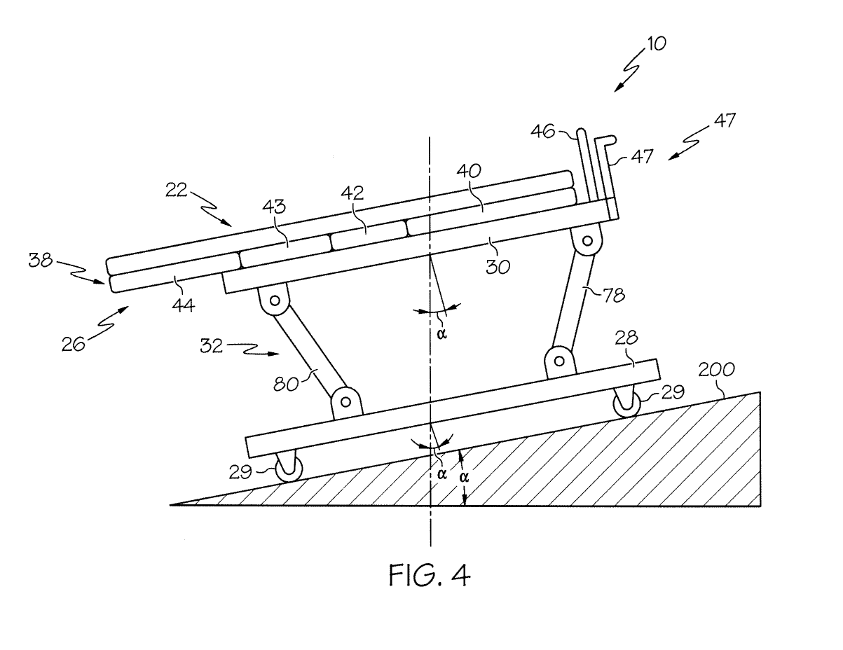

Mattress 22 includes a top surface 34, a bottom surface (not shown), and a perimeter surface 36 as shown in FIGS. 1 and 2. The upper frame 30 carries a patient support deck 38 of frame 20 that engages the bottom surface of mattress 22. The support deck 38, as shown in FIG. 1 and as shown diagrammatically in FIG. 4, includes a head section 40, a seat section 42, a thigh section 43 and a foot section 44. Sections 40, 43, 44 are each movable relative to upper frame 30. For example, head section 40 pivotably raises and lowers relative to seat section 42 whereas foot section 44 pivotably raises and lowers relative to thigh section 43. Additionally, thigh section 43 articulates relative to seat section 42. Also, in some embodiments, foot section 44 is extendable and retractable to change the overall length of foot section 44 and therefore, to change the overall length of deck 38.

In some embodiments, seat section 42 also moves, such as by translating on upper frame 30 as bed 10 moves between the bed position and the chair egress position. Of course, in those embodiments in which seat section 42 translates along upper frame 42, the thigh and foot sections 43, 44 also translate along with seat section 42. As bed 10 moves from the bed position to the chair egress position, foot section 44 lowers relative to thigh section 43 and shortens in length. As bed 10 moves from the chair egress position to the bed position, foot section 44 raises relative to thigh section 43 and increases in length. Thus, in the chair egress position, head section 40 extends generally vertically upwardly from upper frame 30 and foot section extends generally vertically downwardly from thigh section 43 as shown in FIG. 2.

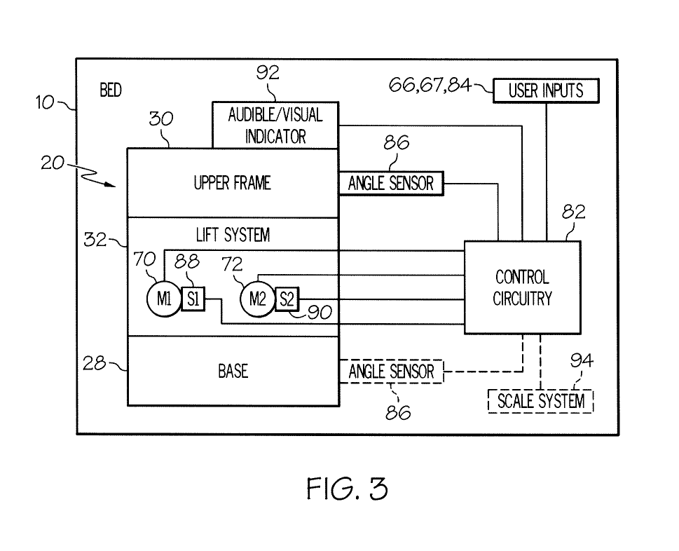

As shown diagrammatically in FIG. 3, lift system 32 of bed 10 includes first and second actuators 70, 72, which in some embodiments, comprise linear actuators with electric motors. Thus, actuators 70, 72 are sometimes referred to herein as motors 70, 72. Alternative actuators contemplated by this disclosure include hydraulic cylinders and pneumatic cylinders, for example. Bed 10 also has actuators such as a head motor for raising and lowering head section 40, a knee motor for articulating thigh section 43 relative to seat section 42, and a foot motor for raising and lowering foot section 44 relative to thigh section 43. The motors for moving sections 40, 43, 44 are not shown. In some embodiments, bed 10 has an additional motor (not shown) for extending and retracting one portion of foot section 44 relative to another portion of foot section 44.

The motors 70, 72 of lift system 32 are operable to raise, lower, and tilt upper frame 30 relative to base 28. In the illustrative embodiment, motor 70 is coupled to, and acts upon, a set of head end lift arms 78 and motor 72 is coupled to, and acts upon, a set of foot end lift arms 80 (only one of which can be seen in FIG. 1) to accomplish the raising, lowering and tilting functions of upper frame 30 relative to base 28. As bed 10 moves from the horizontal bed position of FIG. 1 to the chair egress position of FIG. 2, motors 70, 72 are operated to move arms 78, 80 to lower upper frame 30 toward base 20 if frame 30 is in a raised position to begin with.

User interface 66 includes user inputs that are touched or pressed by a caregiver to operate motors 70, 72. For example, in some embodiments, an up button is used to command operation of motors 70, 72 to raise upper frame 30 relative to base 28 and a down button is used command operation of motors 70, 72 to lower upper frame 30 relative to base 28. In some embodiments, a Trendelenburg button is provided to command operation of motor 70 and/or motor 72 to tilt upper frame 30 into a Trendelenburg position having head end 24 of upper frame 30 lower in elevation than foot end 26 of upper frame 30 and a reverse Trendelenburg button is provided to command operation of motor 70 and/or motor 72 to tile upper frame 30 into a reverse Trendelenburg position having head end 24 of upper frame 30 higher in elevation than foot end 26 of upper frame 30. One or more of these various buttons comprise membrane switches in some embodiments. Alternatively or additionally, these various buttons comprise icons or images on a graphical display screen.

In the illustrative example, bed 10 has four foot pedals 84 coupled to base 28, a first of which is depressed to raise upper frame 30 relative to base 28, a second of which is used to lower frame 30 relative to base 28, a third of which is used to raise head section 40 relative to upper frame 30, and a fourth of which is used to lower head section 40 relative to upper frame 30. In other embodiments, foot pedals 84 are omitted.

It is well known in the hospital bed art that electric drive motors with various types of transmission elements including lead screw drives and various types of mechanical linkages may be used to cause relative movement of portions of patient support apparatuses including raising, lowering, or tilting an upper frame of a bed relative to a base, which in some embodiments includes a lower frame that is covered at least partly by a shroud. It is also well known to use pneumatic or hydraulic actuators to actuate and/or move individual portions of patient support apparatuses. As a result, the term “lift system” as used in the specification and in the claims, therefore, is intended to cover all types of mechanical, electromechanical, hydraulic and pneumatic mechanisms, including manual cranking mechanisms of all types, for raising or lowering or tilting portions of patient support apparatuses, such as illustrative hospital bed 10. Accordingly, the teachings of this disclosure are applicable to lift systems of all types. For example, lift systems using scissors linkage arrangements or using vertically oriented telescoping structures, such as hydraulic cylinders or jack screws, are within the scope of this disclosure.

As shown diagrammatically in FIG. 3, bed 10 includes control circuitry 82 that is electrically coupled to motors 70, 72 of lift system 32. Control circuitry 82 is represented diagrammatically as a single block 82 in FIG. 3, but control circuitry 82 in some embodiments comprises various circuit boards, electronics modules, and the like that are electrically and communicatively interconnected. Control circuitry 82 includes one or more microprocessors or microcontrollers that execute software to perform the various control functions and algorithms described herein. Thus, circuitry 82 also includes memory for storing software, variables, calculated values, and the like as is well known in the art.

As also shown diagrammatically in FIG. 3, a user inputs block represents the various user inputs 66, 67, 84 that are used by the caregiver or patient to communicate input signals to control circuitry 82 of bed 10 to command the operation of the various motors of bed 10, including motors 70, 72, as well as commanding the operation of other functions of bed 10. For example, the user inputs of user interfaces 66, 67 include a head up button which is used to raise head section 40, a head down button which is used to lower head section 40, a knee up button which is used to raise thigh section 43, and a knee down button which is used to lower thigh section. In the illustrative example, user interface 66 also includes a chair button which is used to simultaneously operate the motors of bed associated with moving bed 10 into the chair egress position.

Bed 10 has an angle sensor 86 that, in some embodiments, is coupled to upper frame 30 as shown diagrammatically in FIG. 3 (in solid) and that, in other embodiments, is coupled to base 28 as also shown diagrammatically in FIG. 3 (in phantom). Angle sensor 86 operates to provide a signal indicative of an angle at which upper frame 30 and/or base 28 is tilted away from a substantially horizontal orientation. In the illustrative example, even though angle sensor 86 is coupled to upper frame 30, control circuitry 82 is still able to determine an angle of tilt of base 28 out of a horizontal orientation because sensors 88, 90, respectively, are coupled to motors 70, 72 and provide signals that indicate an amount of tilt of upper frame 30 relative to base 28. Thus, if angle sensor 86 indicates that upper frame 30 is tilted by an amount that does not match the angle of tilt determined based on signals from sensors 88, 90, then the difference is likely due to base 28 being tilted by some amount away from horizontal. Accordingly, in connection with those embodiments in which angle sensor 92 is mounted to upper frame 30, any tilting of upper frame 30 by lift system 32, rather than due to an incline of floor 200, is compensated for mathematically by the software of control circuitry 82.

In some embodiments, sensors 88, 90 associated with motors 70, 72 are potentiometers included as components of linear actuators that include motors 70, 72. In other embodiments, sensors 88, 90 are rotary encoders, such as optical or magnetic encoders, or linear variable displacement transducers (LVDT's), for example. In one embodiment, angle sensor 86 comprises an accelerometer but suitable alternatives include, for example, a pendulum based inclinometer (e.g., a mass that turns a potentiometer), a series of ball switches, or even a mass supported by or suspended from a force sensor, such as a load beam having one or more strain gages, in which a cosine error in an output signal of the force sensor is introduced when the force sensor is titled out of a horizontal orientation.

Bed 10 has an audible and/or visual indicator as shown diagrammatically in FIG. 3, by audible/visual indicator block 94. Indicator 94 is activated to indicate to a caregiver that lift system 32 should be operated by one or more of user inputs 66, 67, 84 to move upper frame 30 to the low position when angle sensor 86 indicates that the angle at which base 28 is titled away from horizontal is greater than a threshold amount such as, for example 3 or 5 degrees. Threshold angles greater than 5 degrees and less than 3 degrees are within the scope of this disclosure as well. The low position may correspond to the lowest possible position of frame 30 relative to base 28 in some embodiments and, in other embodiments, may correspond to a position that is at or below a particular threshold elevation relative to base 28, but not necessarily the lowest possible position of upper frame 30 relative to base 28. In the FIG. 3 illustration, user inputs 66, 67, 84, angle sensor 86, and indicator 92 are shown as components separate from control circuitry 82. However, each of these elements may just as well be considered part of control circuitry 82 according to this disclosure.

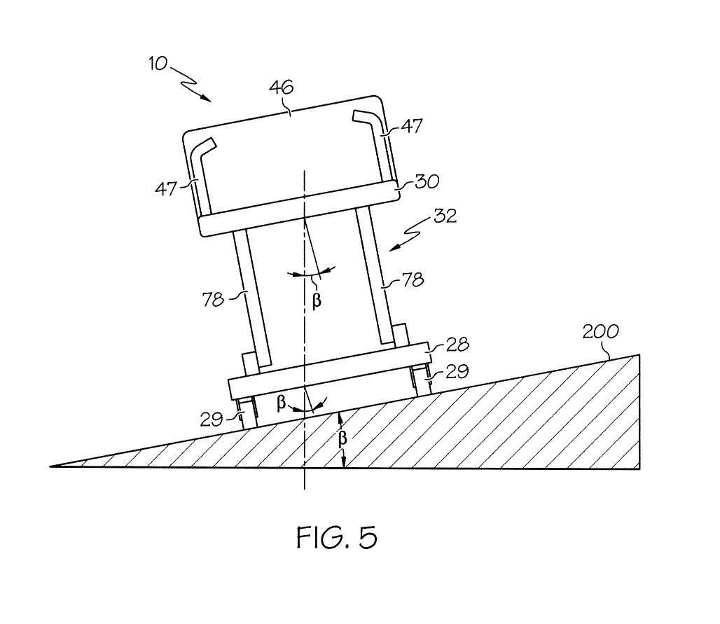

Examples of audible indicators 92 that are within the scope of this disclosure include a wide variety of sound producing devices such as, for example, speakers, buzzers (e.g., piezoelectric buzzers), horns, beepers, and the like. Alternatively or additionally, the audible indicator 92 may include a prerecorded voice message. Examples of visual indicators 92 that are within the scope of this disclosure include, for example, graphical display screens and lights (e.g., light emitting diodes (LED's)) including those that simply light up, flash or change colors. Thus, in those embodiments in which user interface 66 comprises a graphical display screen, part or all of the associated screen may change color, such as turning red, and optionally may flash. The display screen may show graphics, such as a textual message and/or an icon, as the visual indicator 92. Embodiments in which bed 10 has both audible and visual indicators 92 are contemplated by this disclosure. Regardless of the type of indicator used, the general idea is to notify a caregiver that upper frame 30 of the patient support apparatus 10 should be lowered so as to minimize or lessen the chance that the patient support apparatus 10 will tip when bed is being transported over or along an incline such as is shown diagrammatically in FIGS. 4 and 5.

As mentioned above, the angle sensor 86 is mounted to upper frame 30 in some embodiments and is mounted to base 28 in other embodiments. In the illustrative example, upper frame 30 and base 28 are elongated such that bed 10 has a longitudinal direction and a lateral direction. Depending upon the type and/or number of angle sensors 92 employed, tilting in the lateral direction (e.g., side to side) or the longitudinal direction (e.g., head end to foot end) or both is sensed. For example, to sense tilting in the longitudinal direction and the lateral direction, angle sensor 92 may comprise a pair of single axis accelerometers oriented perpendicular to each other so as to be aligned with the lateral and longitudinal directions or may comprise an appropriately oriented single 2-axis accelerometer capable of sensing titling in perpendicular directions.

The longitudinal spacing between the pair of casters 29 at the head end 24 of bed 10 and the pair of casters 29 at the foot end 26 of bed 10 is greater than the lateral spacing between the pair of right side casters 29 and the pair of left side casters 29 as is evident by comparing FIGS. 4 and 5. Accordingly, bed 10 is less susceptible to tipping over in the longitudinal direction than in the lateral direction. Thus, it is within the scope of this disclosure for the threshold angle at which indicator 92 is activated to alert the caregiver to move upper frame 30 to the low position to be greater in the longitudinal direction of bed 10 than in the lateral direction of bed 10. For example, a threshold angle α, shown in FIG. 4, at which indicator 92 is activated in the longitudinal direction is greater in some embodiments than a threshold angle β, shown in FIG. 5, at which indicator 92 is activated in the lateral direction. Of course, this need not be the case such that threshold angles α, β may be the same in the longitudinal and lateral directions of bed 10. The possibility that bed 10 may be turned by a caregiver, or even turned inadvertently, while on an incline would be one reason for having the same threshold angles α, β.

According to this disclosure, the angle measured by angle sensor 92 is with respect to vertical or the direction of gravitational force in some embodiments, and is with respect to horizontal in other embodiments. In still other embodiments, the angle measured by angle sensor 92 is with respect to an arbitrary non-vertical and non-horizontal reference. See, for example, U.S. Provisional Application No. 61/250,276, filed Oct. 9, 2009, which shows and describes a system in which an accelerometer is oriented in a manner in which a measurement reference axis is non-horizontal and non-vertical when a frame to which the accelerometer is mounted is horizontal. U.S. Provisional Application No. 61/250,276 is hereby expressly incorporated by reference herein.

Optionally, bed 10 has a scale system 94 that is coupled to or included as part of control circuitry 94. The scale system 94 is operable to sense an amount of weight carried by upper frame 30. Examples of scale systems used on hospital beds are shown and described in U.S. Pat. Nos. 7,610,637; 7,253,36; 7,253,366; 7,176,391; 6,924,441; 6,680,443; and 5,859,390; each of which is hereby incorporated by reference herein. According to this disclosure, one or more of the threshold angles α, β may be adjusted based on the amount of weight sensed by scale system 94. That is, in some embodiments, if more weight is carried by upper frame 30 (e.g., weight above one or more weight thresholds), then the threshold angle at which indicator 92 is activated is lowered accordingly. Furthermore, in some embodiments, if more weight is carried by upper frame 30, then the elevation of upper frame 30 relative to base 28 that is considered to be the “low position” is reduced.

In some embodiments contemplated by this disclosure, rather than just activating indicator 94 when upper frame 30 is raised above the low position when bed 10 is being transported over an incline exceeding a threshold angle, control circuitry 82 signals motors 70, 72 to automatically lower upper frame 30 down to the low position. In some such embodiments, a delay period of time elapses before motors 70, 72 are operated automatically to give the caregiver time to manipulate an appropriate user input 66, 67, 84 to override the automatic operation of motors 70, 72 or to actuate motors 70, 72 himself or herself. During the delay period, it is possible that the caregiver may move bed 10 back onto a horizontal floor section in which case the automatic operation of motors 70, 72 is cancelled automatically by control circuitry 82.

Although certain illustrative embodiments have been described in detail above, many embodiments, variations and modifications are possible that are still within the scope and spirit of this disclosure as described herein and as defined in the following claims.

1. A patient support apparatus comprising
a base,
an upper frame above the base,
a lift system to raise and lower the upper frame relative to the base between a low position and a high position, and
control circuitry coupled to the lift system, the control circuitry being operable to command operation of the lift system, the control circuitry having an angle sensor providing a signal indicative of an angle at which at least one of the base and the upper frame are tilted away from a substantially horizontal orientation, the control circuitry including an indicator that is activated to indicate to a caregiver that the lift system should be operated to move the upper frame to the low position when the angle sensor indicates that the angle is greater than a threshold amount.

2. The patient support apparatus of claim 1, wherein the indicator includes an audible indicator.

3. The patient support apparatus of claim 2, wherein the audible indicator comprises one of a speaker, buzzer, beeper, and horn.

4. The patient support apparatus of claim 2, wherein the audible indicator includes a prerecorded voice message.

5. The patient support apparatus of claim 1, wherein the indicator includes a visual indicator.

6. The patient support apparatus of claim 4, wherein the visual indicator comprises one of a light, a light emitting diode (LED), and graphics on a graphical display screen.

7. The patient support apparatus of claim 1, wherein the angle sensor is mounted to the upper frame.

8. The patient support apparatus of claim 7, wherein the upper frame is elongated such that the patient support apparatus has a longitudinal direction and a lateral direction and wherein the angle sensor senses tilting in the lateral direction.

9. The patient support apparatus of claim 8, wherein the angle sensor also senses tilting in the longitudinal direction.

10. The patient support apparatus of claim 9, wherein the control circuitry further comprises at least one lift system sensor to sense a position of the lift system such that any tilting of the upper frame by the lift system is compensated for in determining whether the threshold amount is exceeded.

11. The patient support apparatus of claim 10, wherein the lift system comprises first and second actuators and wherein the at least one lift system sensor comprises a first potentiometer coupled to the first actuator and a second potentiometer coupled to the second actuator.

12. The patient support apparatus of claim 1, wherein the angle sensor is mounted to the base.

13. The patient support apparatus of claim 12, wherein the base is elongated such that the patient support apparatus has a longitudinal direction and a lateral direction and wherein the angle sensor senses tilting in the lateral direction.

14. The patient support apparatus of claim 13, wherein the angle sensor also senses tilting in the longitudinal direction.

15. The patient support apparatus of claim 1, wherein the control circuitry further comprises at least one lift system sensor to sense a position of the lift system such that any tilting of the upper frame by the lift system is compensated for in determining whether the threshold amount is exceeded.

16. The patient support apparatus of claim 15, wherein the lift system comprises first and second actuators and wherein the at least one lift system sensor comprises a first potentiometer coupled to the first actuator and a second potentiometer coupled to the second actuator.

17. The patient support apparatus of claim 1, wherein the angle sensor comprises an accelerometer.

18. The patient support apparatus of claim 17, wherein the accelerometer comprises a 2-axis accelerometer operable to measure tilt about a pair of orthogonal axes.

19. The patient support apparatus of claim 1, wherein the base comprises a base frame and casters coupled to the base frame and further comprising a mattress support deck coupled to the upper frame, the mattress support deck being movable between a horizontal position to support a patient in a lying position and a chair egress position to support the patient in a sitting position.

20. The patient support apparatus of claim 1, wherein the control circuitry comprises a scale system operable to sense an amount of weight carried by the upper frame and wherein the threshold amount of the angle is adjusted based on the amount of weight.
